(19) United States
(12) Patent Application Publication
(10) Pub. No.: US 2009/0256764 A1
(43) Pub. Date: Oct. 15, 2009

(54) Antenna device having an adjustable frequency

(75) Inventors: Cheng-Ta Lee, Nantou City (TW); Jui-Chih Chien, Sikou Township (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Universal Scientific Industrial Co., Ltd., Nan-Tou Hsien (TW)

(21) Appl. No.: 12/082,262

(22) Filed: Apr. 9, 2008

(51) Int. Cl. H01Q 9/00

(52) U.S. Cl. 343/749

(57) ABSTRACT

An antenna device includes an antenna and a transmission element. The antenna includes a grounding element and a radiating element. The radiating element is connected to the grounding element and is provided with a plurality of spaced apart feeding portions. The transmission element is connected selectively to one of said feeding portions. When the transmission element is connected to one of the feeding portions, the radiating element operates in a distinct frequency.

### BACKGROUND OF THE INVENTION

1. Field of the Invention

This invention relates to an antenna device, more particularly to an antenna device that has an adjustable frequency.

2. Description of the Related Art

FIGS. 1 and 2 illustrate a conventional antenna device 100 mounted on a circuit board 101. The conventional antenna device 100 includes an antenna, a matching circuit 14, and a transmission element 15. The antenna is a planar inverted-F antenna (PIFA), and includes radiating and grounding elements 11, 12. The matching circuit 14 includes a pair of resistors 141 and a capacitor 142. The transmission element 15 is connected to the antenna and the matching circuit 14.

During operation, the matching circuit 14 adjusts a frequency of the radiating element 11 whenever the frequency of the radiating element 11 deviates from a desired frequency.

The aforementioned conventional antenna device 100 is disadvantageous in that the matching circuit 14 thereof causes signal loss, enlarges a physical size thereof, and increases production costs thereof.

### SUMMARY OF THE INVENTION

Therefore, the object of the present invention is to provide an antenna device that can overcome the aforesaid drawbacks of the prior art.

According to the present invention, an antenna device comprises an antenna and a transmission element. The antenna includes a grounding element and a radiating element. The radiating element is connected to the grounding element and is provided with a plurality of spaced apart feeding portions. The transmission element is connected selectively to one of the feeding portions. When the transmission element is connected to one of the feeding portions, the radiating element operates in a distinct frequency.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic side view of a conventional antenna device;

FIG. 2 is a schematic top view of the conventional antenna device of FIG. 1;

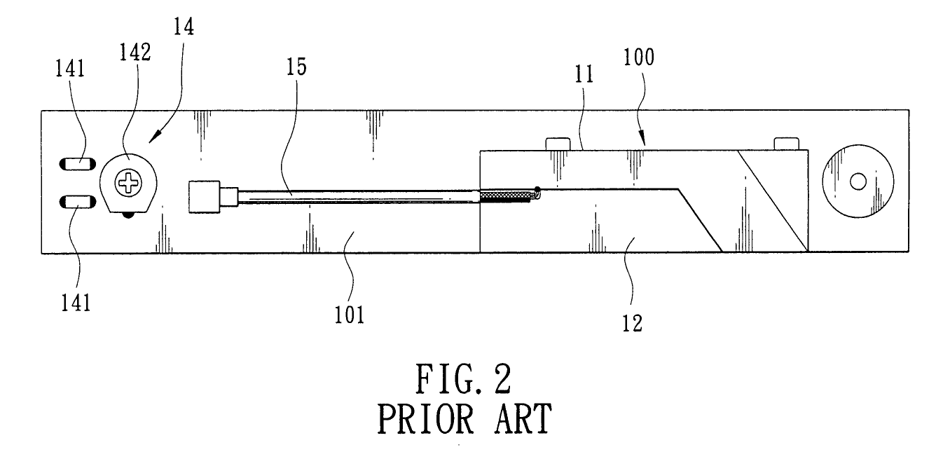

FIG. 3 is a perspective view of the preferred embodiment of an antenna device according to the present invention;

FIG. 4 is a schematic side view of the preferred embodiment of FIG. 3; and

FIG. 5 is a schematic top view of the preferred embodiment of FIG. 3.

### DETAILED DESCRIPTION OF THE PREFERRED EMBODIMENT

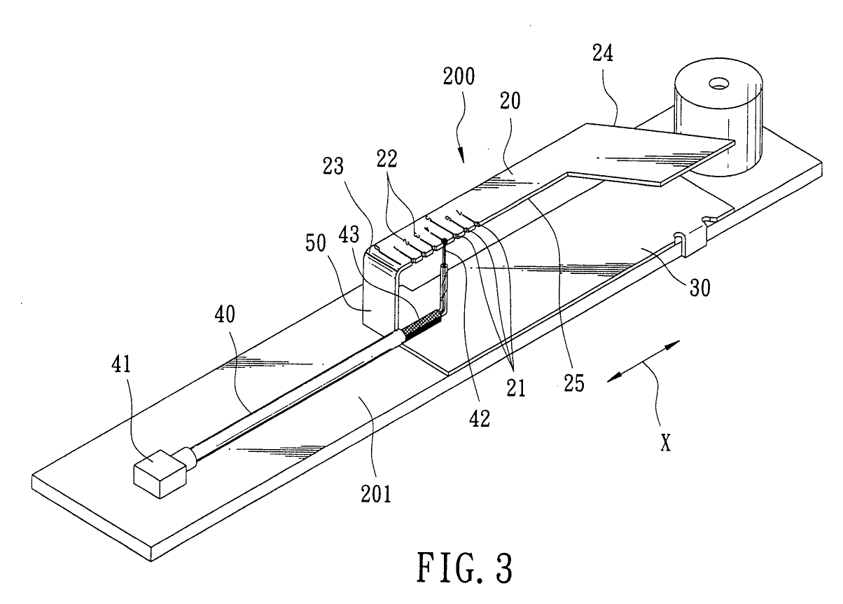

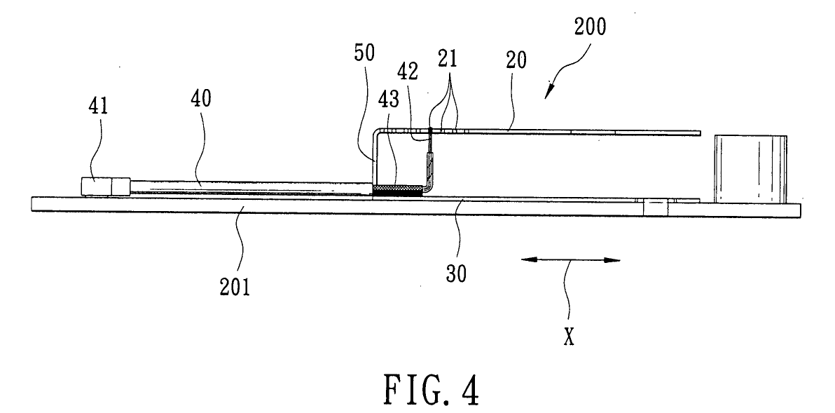

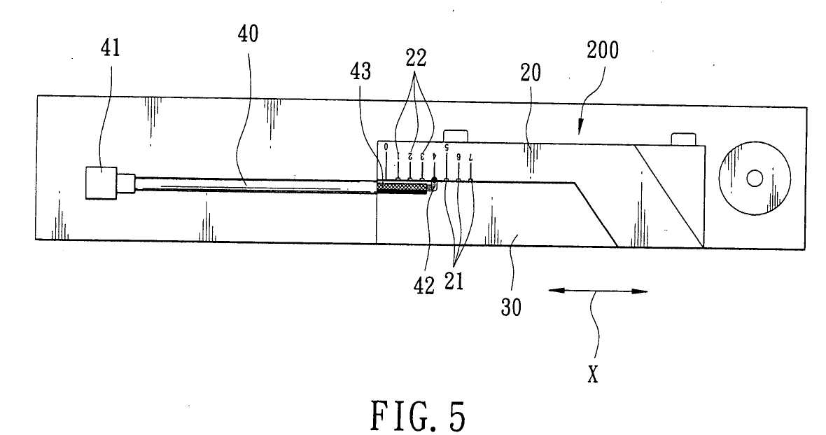

Referring to FIGS. 3 to 5, the preferred embodiment of an antenna device 200 according to this invention is shown to include an antenna and a transmission element 40.

The antenna device 200 of this invention is mounted on a circuit board 201 of an electronic device (not shown).

The antenna is a planar inverted-F antenna, and includes a grounding element 30 and a radiating element 20.

The grounding element 30 is connected electrically to an electrical ground (not shown) of the circuit board 201.

The radiating element 20 has first and second edges 23, 24 that are opposite to each other in a longitudinal direction (X), has a third edge 25 that extends in the longitudinal direction (X) and that interconnects the first and second edges 23, 24, and is provided with a plurality of feeding portions 21 that are spaced apart along the third edge 25 thereof. The third edge 25 of the radiating element 20 is formed with a plurality of grooves, each of which is defined by a groove-defining wall. Each of the feeding portions 21 is defined by the groove-defining wall of a respective one of the grooves. In this embodiment, the feeding portions 21 are spaced apart at equal distances. Preferably, the feeding portions 21 are spaced apart by one millimeter. In an alternative embodiment, the feeding portions 21 are spaced apart at different distances.

The radiating element 20 is marked with gradations 22, i.e., from “1” to “7”, that are disposed adjacent to the feeding portions 21.

The antenna further includes a connector 50 that interconnects the grounding element 30 and the first edge 23 of the radiating element 20. As such, the feeding portions 21 are disposed at different distances with respect to the connector 50.

The transmission element 40 has first and second terminals 41, 42, and a shield 43. The first terminal 41 of the transmission element 40 is connected to a circuit (not shown) of the circuit board 201. The second terminal 42 of the transmission element 40 is connected selectively to one of the feeding portions 21. The shield 43 of the transmission element 40 is connected to the grounding element 30.

It is noted that the second terminal 42 of the transmission element 40 may be connected to the feeding portion 21 by inserting the second terminal 42 into the groove that corresponds to the feeding portion 21. Moreover, when the second terminal 42 of the transmission element 40 is connected to one of the feeding portions 21, the radiating element 20 operates in a distinct frequency. Further, the farther the feeding portion 21 from the connector 50 to which the second terminal 42 of the transmission element 40 is connected, the higher the frequency at which the radiating element 20 operates.

As an example of an application of the antenna device 200 of this invention, when the electronic device is a Bluetooth device that operates between the 2.4 GHz and 2.5 GHz frequency band and when a frequency difference between each adjacent pair of the feeding portions 21 is 20 MHz, the second terminal 42 of the transmission element 40 is simply connected to one of the feeding portions 21 such that the radiating element 20 operates at or close to a frequency, i.e., a center frequency, of 2.45 GHz.

Although the frequency difference between the adjacent pairs of the feeding portions 21 is exemplified as 20 MHz, it should be apparent to those skilled in the art that the frequency difference between each of the adjacent pairs of the feeding portions 21 may be increased or decreased as required.

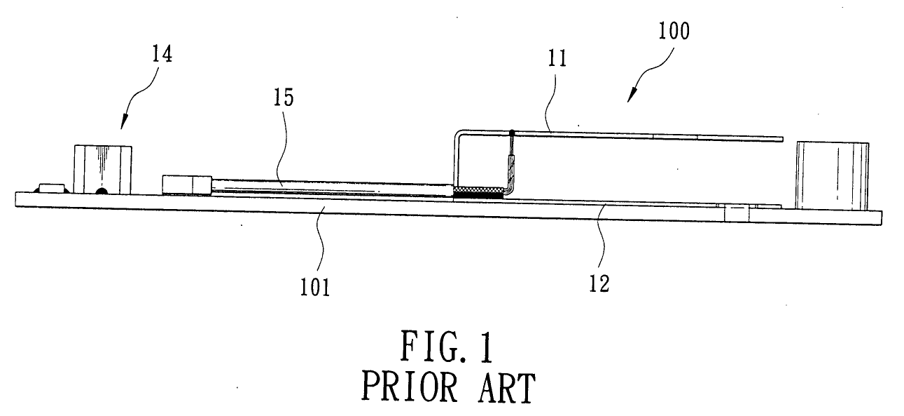

It has thus been shown that the antenna device 200 of this invention includes an antenna and a transmission element 40. The antenna includes a grounding element 30 and a radiating element 20. The radiating element 20 is connected to the grounding element 30 and has a plurality of feeding portions 21. The transmission element 40 is connected selectively to one of the feeding portions 21 to thereby adjust a frequency at which the radiating element 20 operates. As such, unlike the conventional antenna device 100 (see FIG. 1), the antenna device 200 of this invention may dispense with the matching circuit 14 (see FIG. 1). This results in relatively low production costs, a reduced signal loss, and a small physical size for the antenna device 200 of this invention.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An antenna device, comprising:
an antenna including
a grounding element, and
a radiating element connected to said grounding element and provided with a plurality of spaced apart feeding portions; and
a transmission element connected selectively to one of said feeding portions;
wherein when said transmission element is connected to one of said feeding portions, said radiating element operates in a distinct frequency.

2. The antenna device as claimed in claim 1, wherein said antenna further includes a connector, said radiating element being connected to said grounding element through said connector.

3. The antenna device as claimed in claim 1, wherein said radiating element extends in a longitudinal direction, and said feeding portions are disposed along the longitudinal direction.

4. The antenna device as claimed in claim 3, wherein said feeding portions are spaced apart at equal distances.

5. The antenna device as claimed in claim 3, wherein said feeding portions are spaced apart at different distances.

6. The antenna device as claimed in claim 1, wherein said radiating element has an edge that extends in the longitudinal direction, and that is formed with a plurality of grooves, each of which is defined by a groove-defining wall,
each of said feeding portions being defined by said groove-defining wall of a respective one of said grooves.

7. The antenna device as claimed in claim 4, wherein said radiating element is marked with gradations disposed adjacent to said feeding portions.
